(19) United States
(12) Patent Application Publication
(10) Pub. No.: US 2019/0335652 A1
(43) Pub. Date: Nov. 7, 2019

(54) SPRIG PLUGGER DEVICE, SYSTEM AND METHOD

(71) Applicant: Gabriel Luce, Salem, SC (US)

(72) Inventor: Gabriel Luce, Salem, SC (US)

(21) Appl. No.: 16/396,828

(22) Filed: Apr. 29, 2019

Related U.S. Application Data
(60) Provisional application No. 62/665,832, filed on May 2, 2018.

(51) Int. Cl. A01C 11/00; A01C 7/00

(52) U.S. Cl. CPC A01C 11/00; A01C 7/008

(57) ABSTRACT

Disclosed is a system and method that provides a sprig plugger that inserts sprigs into soil using a movable tine in conjunction with an aerator or purpose-built mechanical sprig plugger.

### CROSS-REFERENCE TO RELATED APPLICATIONS

This application claims the benefit of and priority to U.S. Provisional Patent 62/665,832, filed May 2, 2018, which is incorporated in its entirety in this document by reference.

### TECHNICAL FIELD

The present disclosure generally relates to a grass renovation system and, more particularly, to a sprig plugger system and method that inserts sprigs into a desired area through direct sprig planting using a movable tine in conjunction with an aerator.

### BACKGROUND

Dead and/or undesirable spots in grassy areas have long posed a problem. Partial or complete re-sodding generally works but there is the problem of matching the new sod with the surrounding grass and the expense and logistics involved with a sodding operation. Another method is manual plugging, in which a cutter is used to transplant small pieces of sod and soil to an area. Re-sodding or manually plugging an area can be very invasive especially in a high traffic and financially necessary area such as a golf green or collar. These methods can be useful on golf courses in certain situations, but faster and more cost-effective repair methods are required, for areas both small and large. What is needed is a system and method of re-growing grass more quickly at lower cost.

Current processes and machines used for turf renovation are cumbersome and time consuming. Current re-grassing and renovation using sprigs requires exposing soil, excessive fertilizer and frequent water until established. Current machines used for mechanically introducing sprigs into soil are used for areas with no existing grass and are used for large areas. Sodding is a way for quicker establishment than traditional sprigging but requires removal of existing turf or grass mixes and is often hard to match due to grain and slab height when patching. Sod is also very costly and invasive to the space while being installed and grown in. Also, some grasses such as grasses for putting greens are not offered in sod form.

The concept of sprig planting has been known for hundreds of years but the manual process is time consuming and tedious, requiring individual insertion of grass stolons and rhizomes into sod or soil. Sprigs can be preferable over sod because one can use the same type of grass to directly insert into dead areas without disturbing the existing form and smoothness of the area. Sprigs can also be preferable over grass seed because many grass biotypes are not available in seed form. What is needed is a method of automating the process of sprig planting for faster and more cost-effective insertion (plugging) into desired areas.

Sprigs can also be useful for replacing the type of grass in an area, such as zoysia replacement of tall fescue often performed in southern climates. Again, however, conventional sprig planting and traditional manual plugging can be too time consuming and expensive to attempt on a large area.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a sprig plugger device, system and method that automates the process of sprig plugging using a sprig tine designed for use on a standard aerator or a specifically designed mechanical sprig plugger. The sprig tine can be configured for use on most commercial and residential aerators to provide sprig plugging for repair of dead grass areas and replacement of grass type. It can also be configured to operate on a purpose-built mechanical sprig plugger.

The sprig tine is generally a flat elongated member sized to fit into an aerator tine holder, where the ends are rounded to insert sprigs into soil. Common shank sizes for standard aerators for the tine are ½ inch and ¾ inch but may vary with the specific application and aerator used.

The present disclosure provides a sprig plugger system for inserting springs into a desired area comprising: an aerator; a tine holder coupled to the aerator; and a sprig tine coupled to the tine holder, wherein the sprig tine is comprised of an elongated member with a proximal end to provide a surface area for forcibly inserting a sprig into the soil and an opposed distal end to provide a mating surface for connection of the sprig tine to the tine holder, wherein the tine holder is movable about and between a first holder position, in which the sprig tine is spaced from the soil a predetermined distance, and a second holder position, in which at least a portion of the proximal end of the tine is inserted into the soil.

The present disclosure also provides a method of using a sprig plugger for inserting sprigs into soil of a desired area, the method comprising the steps of: providing an aerator; providing a tine holder coupled to the aerator; providing at least one sprig tine coupled to the tine holder, wherein each sprig tine is comprised of an elongated member with a proximal end to provide a surface area for forcibly inserting sprigs into soil and an opposed distal end to provide a mating surface for connection of the tine holder, wherein the tine holder is movable about and between a first holder position, in which the sprig tine is spaced from the soil a predetermined distance, and a second holder position, in which at least a portion of the proximal end of the tine is inserted into the soil; and operating said aerator to forcibly insert sprigs into soil.

The present disclosure also provides a purpose-built sprig plugger for inserting sprigs into soil of a desired area comprising: a tine holder movable about and between a first holder position and a second holder position; and a sprig tine coupled to the tine holder, wherein the sprig tine is comprised of an elongated member with a proximal end to provide a surface area for forcibly inserting the sprigs into the soil and an opposed distal end to provide a mating surface for connection of the sprig tine to the tine holder, and wherein in the first holder position the sprig tine is spaced from the soil a predetermined distance, and in the second holder position at least a portion of the proximal end of the tine is inserted into the soil.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIG. 1 is a rear view of a sprig plugger comprising a plurality of sprig plugger tines configured to insert sprigs into soil, according to one aspect of the present disclosure.

FIG. 2A is a front view of a sprig plugger tine of the plurality of sprig pluggers tines of FIG. 1, according to one aspect of the present disclosure.

FIG. 2B is a side view of a sprig plugger tine of the plurality of sprig pluggers tines of FIG. 1, according to one aspect of the present disclosure.

FIG. 3 is a bottom view of an aerator using tines of a sprig plugger to insert sprigs into soil according to one aspect of the present disclosure, the sprig plugger further comprising a gathering mechanism.

FIG. 4 is a side view of an aerator using sprig plugger tines to insert sprigs into soil according to one aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a tine” can include two or more such tines unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a sprig plugger system, device and method for inserting sprigs such as stolons and rhizomes into soil, according to various aspects. In one aspect, the sprig plugger comprises a plurality of tines configured to move vertically relative to the soil in order to urge the sprigs into the soil. In order to actuate the tines, the sprig plugger can be coupled to a conventional aerator, or optionally can be formed integrally with a means for actuating the tines. Also disclosed is a method of using a sprig plugger to insert sprigs into soil.

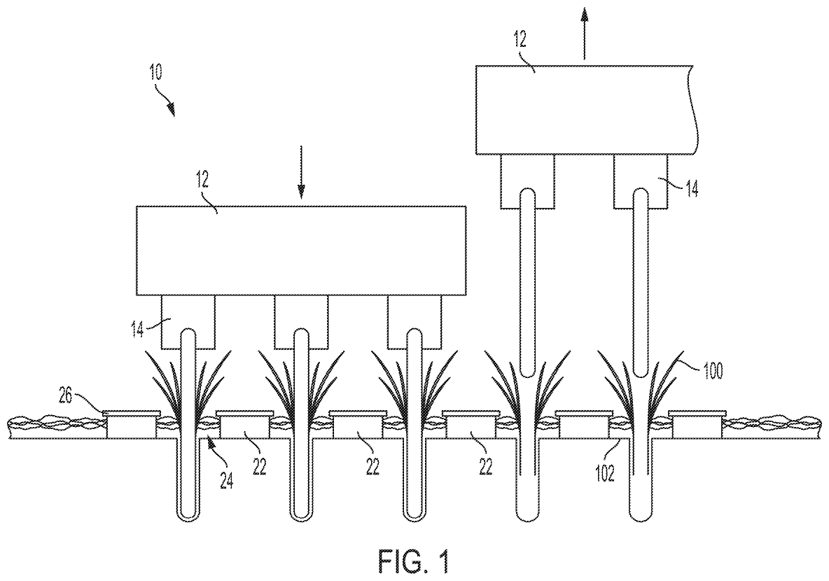

Referring now to FIG. 1, a rear view of a sprig plugger 10 inserting sprigs 100 into soil 102 is provided. In one aspect, the sprig plugger 10 comprises at least one tine holder 12 and a plurality of sprig tines 14 coupled to the tine holder 12. As shown in FIG. 1, the sprig plugger 10 is moving away from the viewer (into the page) with the tines 14 moving up and down vertically. For example, the tines 14 coupled to the tine holders 12 on the left of the sprig plugger 10 of FIG. 1 are forcibly inserting sprigs 100 into the soil 102. The tines 14 coupled to the tine holder 12 on the right of FIG. 1 are shown extracted from the soil 102.

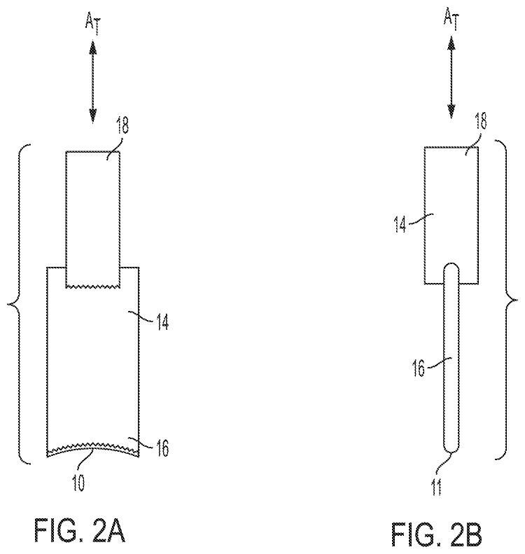

Referring now to FIGS. 2A and 2B, a tine 14 is illustrated, according to one aspect. The tine 14 can be an elongate member having a proximal end 16 and an opposed distal end 18. The distal end 18 of the tine 14 can be configured to be securedly attached to the tine holder 12. For example, the distal end 18 can be substantially circular in cross-sectional shape for secured attachment to the tine holder 12. The proximal end 16 of the tine 14 can be configured to urge a sprig into the ground. For example, and in one aspect, the proximal end 16 of the tine 14 can be concave when viewed from a front view, as illustrated in FIG. 2A. Optionally, in other aspects (not shown), the proximal end 16 of the tine 14 can be convex, flat, wedge-shaped, cross-shaped, teardrop-shaped, hammerhead-shaped, or any other shape when viewed from a front view. FIG. 2B shows a side view of the tine 14 of FIG. 2A. In one aspect, the proximal end 16 of the tine 14 can be rounded when view from the side. Optionally, however, the proximal end 16 of the tine 14 can be flat, wedge-shaped, cross-shaped, teardrop-shaped, hammerhead-shaped, or any other shape when viewed from a side view.

In one aspect, the shape of the proximal end 16 of the tine 14 can be selected based at least in part on the specific sprig and soil conditions encountered in any specific instance. That is, the shape of the proximal end 16 of the tine 14 can vary significantly to suit the specific soil and sprig types involved. Thus, the exact shape of the tine 14 need not be the same in all applications. Instead, the design and shape of the proximal end 16 of the tine 14 can be selected to encourage proper insertion of sprigs into the soil or sod with minimal or no damage to sprigs.

Each tine holder tine 12 of the plurality of tine holders 12 can be configured to move about and between a first holder position, in which any tine 14 coupled to the tine holder 12 is spaced from the soil 102 a predetermined distance (as illustrated on the right side of FIG. 1) and a second holder position, in which at least a portion of the proximal end 16 of a tine 14 coupled to the tine holder 12 is inserted into the soil 102 (as illustrated on the left side of FIG. 1). In one aspect, adjacent tine holders 12 can each be in the first holder position simultaneously. Optionally, in other aspects, a first tine holder 12 can be in the first holder position, and an adjacent second tine holder 12 can be in the second holder position simultaneously.

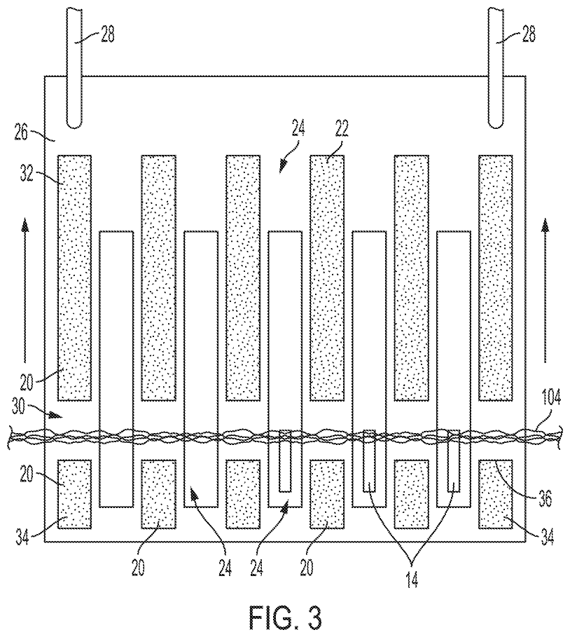

Optionally, in one aspect and as illustrated in FIGS. 1 and 3, the sprig plugger 10 further comprises a sprig gathering element 20 coupled to the sprig plugger 10. In use, described more fully below, the sprig gathering element 20 can be sized and configured to encourage sprigs 100 to be positioned under the tines 14 for insertion into the soil 102.

The sprig gathering element 20 comprises a plurality of elongate turf holding members 22 spaced from each other a predetermined amount so that an elongate slot 24 having a desired slot width can be defined between adjacent turf holding members 22. The turf holding members 22 can be coupled to a mounting plate 26 to maintain the desired slot dimensions. The mounting plate 26 can in turn be coupled to the sprig plugger 10 or directly to the aerator (not shown in FIG. 3) with a bracket 28 and the like. Optionally, the bracket 28 can be coupled to the aerator or to the sprig plugger 10 to provide a spring-loaded mounting plate configured to urge the turf holding members 22 toward the soil. As can be appreciated, a variety of brackets 28 can be provided so that the sprig gathering element 20 can be coupled to aerators produced by different manufacturers.

In one aspect, each elongate slot 24 can be aligned with a tine 14 so that as a tine holder 12 moves between the first holder position and the second holder position, the proximal end 16 each tine 14 can pass through the slot 24 in order to insert a sprig 100 into the soil 102. That is, in the first holder position, the proximal end 16 of a tine 14 can be positioned above an elongate slot 24, and in the second holder position, at least a portion of the proximal end 16 of the tine 14 can be positioned below the elongate slot 24 and with a portion of the tine 14 extending through the slot 24.

In yet another aspect, a gap 30 having a predetermined gap length can be defined in each of the turf holding members 22 such that each turf holding member 22 is separated into a distal turf holding member 32 and a proximal turf holding member 34. In this aspect, the gap 30 can be positioned such that it is adjacent to or near the tines 14. In use, described more fully below, the gap 30 can be configured to gather sprigs 100 for alignment with a tine 14. For example, sprigs 100 positioned on top of the soil 102 can slide underneath the distal turf holding member 32 as the sprig plugger 10 moves across the soil 102. As the sprig 100 reaches the gap 30, the sprig 100 can pop up in the gap 30 and can be caught by a front edge 36 of the proximal turf holding member 34 to create a substantially horizontal line 104 of sprigs 100.

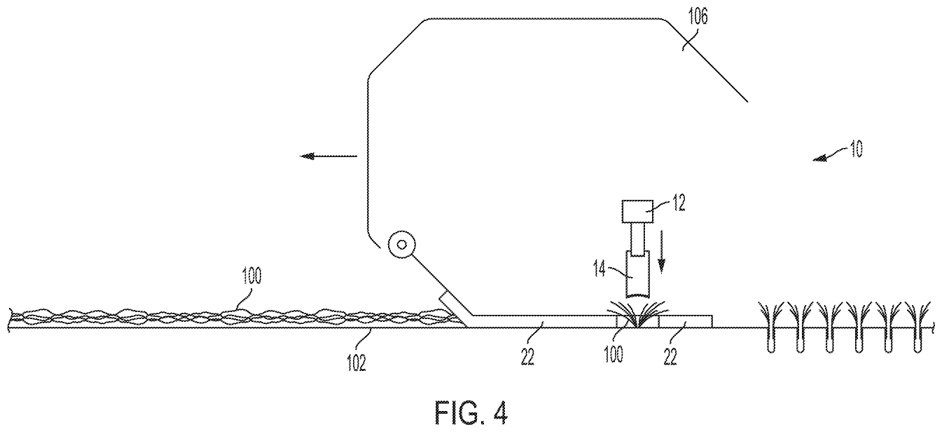

Referring now to FIG. 4, a side view of the sprig plugger 10 coupled to an aerator 106 in use is provided, according to a one aspect. The aerator 106 is illustrated moving from right to left in operation as the sprig plugger 10 inserts sprigs 100 into the soil 102. In this aspect, the tine holder 12 is operably connected to at least one tine 12, which moves up and down forcibly inserting sprig 100 into soil 102.

If the optional turf holding members 22 are provided, the turf holding members 22 can slide along the surface of the soil 102 pressing down sprigs 100 laying in front of the aerator 106. Turf holding members 22 are not required for operation but can allow the device to perform better in some instances. As the aerator 106 moves along the surface of the soil 102, the sprigs 100 can gather in the gap 30 (FIG. 3) between the distal turf holding member 32 and the proximal turf holding member 34. These sprigs 100 positioned in the gap 30 can be caught by the front edge 36 of the proximal turf holding member 34. Any sprigs 100 positioned below the proximal end 16 of a tine 14 are then forcibly inserted into soil 102 as the tine 14 moves from the first holder position to the second holder position.

To repair or rejuvenate a desired area, in one aspect, sprigs 100 can be spread around the area. The sprig plugger 10 can then be moved over the area until a desired amount of the sprigs 100 have been inserted into the soil 102 of the area. Optionally, an herbicide can be used to kill any undesired vegetation prior to spreading the sprigs 100. In another option, a heavy roller can be used to close the soil 102 after the sprigs 100 have been inserted into the soil 102.

It is noted that the sprig plugger 10 operates with a standard aerator 106 and in other embodiments without a standard aerator 106. Although one embodiment is designed for easy retrofit to standard aerators 106, the sprig plugger 10 can operate equally well in a purpose-built mechanical sprig plugger. This is because the sprig plugger 10 inserts sprigs 100 into desired areas, such as dead grassy areas, and does not require operation of an aerator 106. For example, a purpose-built mechanical sprig plugger could be configured to move the tine holders 12 about and between the first holder position and the second holder position. A person of ordinary skill would understand that the novel tine 12 of the sprig plugger 10 can be configured in multiple applications for operation similar to that set forth herein.

The sprig plugger 10 can be used in many different applications. On golf greens, the sprig plugger 10 can be used to push sprigs 100 under the existing turf canopy and into existing soil 102. The dominant turf sprigs can take over existing non-dominant and/or dead turf while minimally disrupting play during and after installation. This is possible because the sprigs 100 are underground and require only normal irrigation. In lawns, the sprig plugger 10 can offer homeowners a cheaper alternative to sodding. Thus, for example, landscaping or turf care companies could use the sprig plugger 10 to install or revitalize the lawn of a homeowner. In one aspect, use of the sprig plugger 10 can be beneficial for soil aeration and soil health.

The sprig plugger 10 can also be manufactured into a purpose-built unit for retail and rentals. In another aspect, a macerator could be used to manufacture sprigs 100 from sod on site and scatter them before injection.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A sprig plugger for inserting sprigs into soil of a desired area comprising:
an aerator;
a tine holder coupled to the aerator; and
a sprig tine coupled to the tine holder, wherein the sprig tine is comprised of an elongated member with a proximal end to provide a surface area for forcibly inserting a sprig into the soil and an opposed distal end to provide a mating surface for connection of the sprig tine to the tine holder,
wherein the tine holder is movable about and between a first holder position, in which the sprig tine is spaced from the soil a predetermined distance, and a second holder position, in which at least a portion of the proximal end of the tine is inserted into the soil.

2. The sprig plugger of claim 1, wherein the tine holder comprises a plurality of tine holders, and wherein the sprig tine comprises a plurality of sprig tines.

3. The sprig plugger of claim 2, further comprising a sprig gathering element configured to encourage sprigs to be positioned under the tines for insertion into the soil.

4. The sprig plugger of claim 3, wherein the sprig gathering element comprises a plurality of elongate turf holding members spaced from each other a predetermined amount so that an elongate slot having a desired slot width is defined between adjacent turf holding members, wherein each slot is aligned with a tine so that as a tine holder of the plurality of tine holders moves between the first holder position and the second holder position, the proximal end of each tine can pass through an elongate slot.

5. The sprig plugger of claim 4, wherein a gap having a predetermined gap length is defined in each of the turf holding members such that each turf holding member is separated into a distal turf holding member and a proximal turf holding member, wherein the gap is positioned adjacent to the tines, and wherein a front edge of the proximal turf holding member creates a substantially horizontal line of sprigs.

6. The sprig plugger of claim 1, wherein the sprig tine is a flat elongated member and wherein the proximal end is substantially rounded.

7. The sprig plugger system of claim 6, wherein the shape of the substantially rounded proximal end of the sprig tine is concave.

8. A method of using a sprig plugger for inserting sprigs into soil of a desired area, the method comprising the steps of:
providing an aerator;
providing a tine holder coupled to the aerator;
providing at least one sprig tine coupled to the tine holder, wherein each sprig tine is comprised of an elongated member with a proximal end to provide a surface area for forcibly inserting sprigs into soil and an opposed distal end to provide a mating surface for connection of the tine holder,
wherein the tine holder is movable about and between a first holder position, in which the sprig tine is spaced from the soil a predetermined distance, and a second holder position, in which at least a portion of the proximal end of the tine is inserted into the soil; and
operating said aerator to forcibly insert sprigs into soil.

9. The method of claim 8, wherein the tine holder comprises a plurality of tine holders, and wherein the at least one sprig tine comprises a plurality of sprig tines.

10. The method of claim 9, further comprising the step of providing a sprig gathering element coupled to the aerator and configured to encourage sprigs to be positioned under the tines for insertion into the soil.

11. The method of claim 10, wherein the sprig gathering element comprises a plurality of elongate turf holding members spaced from each other a predetermined amount so that an elongate slot having a desired slot width is defined between adjacent turf holding members, wherein each slot is aligned with a tine so that as a tine holder of the plurality of tine holders moves between the first holder position and the second holder position, the proximal end of each tine can pass through an elongate slot.

12. The method of claim 11, wherein a gap having a predetermined gap length is defined in each of the turf holding members such that each turf holding member is separated into a distal turf holding member and a proximal turf holding member, wherein the gap is positioned adjacent to the tines, and wherein a front edge of the proximal turf holding member creates a substantially horizontal line of sprigs.

13. The method of claim 12, wherein the at least one sprig tine is a flat elongated member and wherein the proximal end is substantially rounded.

14. The method of claim 13, wherein the shape of the substantially rounded proximal end of the sprig tine is concave.

15. A purpose-built sprig plugger for inserting sprigs into soil of a desired area comprising:
a tine holder movable about and between a first holder position and a second holder position;
a sprig tine coupled to the tine holder, wherein the sprig tine is comprised of an elongated member with a proximal end to provide a surface area for forcibly inserting the sprigs into the soil and an opposed distal end to provide a mating surface for connection of the sprig tine to the tine holder, and wherein in the first holder position the sprig tine is spaced from the soil a predetermined distance, and in the second holder position at least a portion of the proximal end of the tine is inserted into the soil.

16. The sprig plugger of claim 15, wherein the tine holder comprises a plurality of tine holders, and wherein the sprig tine comprises a plurality of sprig tines.

17. The sprig plugger of claim 16, further comprising a sprig gathering element configured to encourage sprigs to be positioned under the tines for insertion into the soil.

18. The sprig plugger of claim 17, wherein the sprig gathering element comprises a plurality of elongate turf holding members spaced from each other a predetermined amount so that an elongate slot having a desired slot width is defined between adjacent turf holding members, wherein each slot is aligned with a tine so that as a tine holder of the plurality of tine holders moves between the first holder position and the second holder position, the proximal end of each tine can pass through an elongate slot.

19. The sprig plugger of claim 18, wherein a gap having a predetermined gap length is defined in each of the turf holding members such that each turf holding member is separated into a distal turf holding member and a proximal turf holding member, wherein the gap is positioned adjacent to the tines, and wherein a front edge of the proximal turf holding member creates a substantially horizontal line of sprigs.

20. The sprig plugger of claim 19, wherein the sprig tine is a flat elongated member and wherein the proximal end is substantially rounded.
